(19) United States
(12) Patent Application Publication
(10) Pub. No.: US 2025/0166461 A1
(43) Pub. Date: May 22, 2025

(54) 6-CARD BACCARAT PROGRESSIVE BET GAMING EVENT

(71) Applicant: Timothy Caffarelli, Las Vegas, NV (US)

(72) Inventor: Timothy Caffarelli, Las Vegas, NV (US)

(21) Appl. No.: 19/013,143

(22) Filed: Jan. 8, 2025

Related U.S. Application Data
(63) Continuation-in-part of application No. 17/460,210, filed on Aug. 28, 2021.

(51) Int. Cl. G07F 17/32; G06F 7/58

(52) U.S. Cl. CPC G07F 17/3258; G06F 7/588; G07F 17/3225; G07F 17/3267; G07F 17/329

(57) ABSTRACT

A system and method of executing a game of baccarat with a progressive side bet event, the system comprising: a gaming table (physical or virtual) having positions thereon for placing an initial wager at the gaming table on the game of baccarat; the gaming table having positions thereon for placing a second wager on a progressive side bet event from at least one of at least two player positions at the gaming table on the game of baccarat resolved by using final playing cards dealt to the player hand position and final playing cards dealt to the banker hand position, wherein the outcome of the side bet event must always be determined by occurrence of a qualifying event of a final total of six playing cards being in play at the conclusion of a round of baccarat.

### BACKGROUND OF THE INVENTION

### 1. Field of the Invention

The present invention relates to the field of wagering events, wagering events involving the wagering event of baccarat, and especially jackpot events used in combination with baccarat.

### 2. Background of the Art

Baccarat is one of the many live table games played in casinos or gaming establishments. Baccarat uses a standard deck of 52 playing cards and is usually dealt from a shoe having multiple decks that have been shuffled together prior to the beginning of play.

The object of the game of Baccarat is for the bettor to successfully wager on whether the Banker's hand or the Player's hand is going to win according to standard rules of play. The bettor receives even money for his wager if he selects the winning hand and loses his wager if he selects the losing hand. Because of the rules of play of Baccarat and more particularly the pre-established draw rules, the Banker's hand has a slightly higher chance of winning than does the Player's hand. The winning frequency for the Banker's hand has been determined to be 0.45859 (45.859%) whereas the winning frequency for the Player hand is 0.44624 (44.624%) with the remainder of the outcomes being ties. Therefore, if the bettor wagers on the Banker's hand and the Banker hand wins, the bettor must pay to the gaming establishment a commission (typically, 5%) of the amount the bettor wins. No commission is paid if the bettor successfully wagers on the Player's hand.

As used in this specification, the term “Conventional Manner of Play of Baccarat” is as follows:

A multiple number of decks of standard playing cards, 52 in number, are used. Typically eight decks are shuffled together and placed in a shoe from which the cards are dealt during the play of the game.

Each bettor makes a wager on whether the Banker's hand or the Player's hand will win. After all wagers are made, two cards are dealt from the shoe to the Banker position and two cards are dealt from the shoe to the Player position on the table layout. The cards are turned face up and the value of the Banker hand and the Player hand is determined, modulo ten.

Aces count one; Kings, Queens, Jacks and Tens count zero and the other cards count (modulo, with counts over 10 reverting to the last digit only) their respective face value. The suits (Spades, Hearts, Diamonds and Clubs) have no meaning in Baccarat.

The highest hand value in Baccarat is nine. All hand values range from a low of zero to a high of nine. If when the cards are added together, the total of the hand exceeds nine, then the hand value is determined modulo ten. For example, a seven and an eight total fifteen, but the hand value is five. An Ace and a nine total ten, but the hand value is zero.

A two card total of eight or nine is called a “natural”; a two card total of zero is called a “baccarat.” As will be explained below, in certain situations in the play of the game, a third card will be dealt. The value of this third card is added to the total of the first two cards and a new hand value is established. Again, if the new 3-card hand total exceeds nine, the 3-card hand value is determined by subtracting ten from the total of the hand.

Prior to the deal, each bettor can make one of three wagers: 1) that the Banker hand will win; 2) that the Player hand will win; or 3) that the Banker hand and the Player hand will tie. Wagering locations are provided on the Baccarat table layout. Whichever of the Banker hand or the Player hand is closest to a total on nine is the winner.

All winning Banker hand wagers are paid off at odds of one-to-one and the house charges a five percent (5%) commission on the amount won by the bettor. For example, if a bettor wagers $100 on the Banker hand and the Banker hand wins, the bettor wins $100 and is charged a $5 commission on the amount that the bettor won. The bettor is not charged any commission on the amount of his wager.

All winning Player hand wagers are paid off at odds of one-to-one and the bettor is not charged any commission on the amount of his winnings or his wager because the house, by virtue of the third card draw rules, has a statistical advantage over the player of 45.859-44.624 or 1.235% which is the vigorish (“vig”) of the house on player wagers. Winning wagers on the Tie hand bet are paid off at odds of nine-to-one or eight-to-one (depending on the gaming establishment) and the bettor is not charged any commission on the amount of his winnings or his wager since there is already a statistical advantage in favor of the house on tie wagers. If a Tie hand occurs, all wagers on the Banker hand and all wagers on the Player hand are “pushes” and the amount wagered is returned to the bettor.

Depending on the point total of the Player's hand and the Banker's hand, one additional card may be dealt to either the Player's hand, the Banker's hand or both. The rules for determining whether a third card is dealt are fixed rules, there is no discretion for either the Player's hand or the Banker's hand on whether a third card is dealt.

If either the Player hand or the Banker hand has a point total of eight or nine on the first two cards, no third card is dealt to either hand and the hand with the highest point total is the winner (or the hand is a Tie, as the case may be). If neither the Player hand nor the Banker hand has a point total of eight or nine, then there is a possibility of a third card draw.

The third card draw rules are as follows:
Rule #1: If the initial two card Player hand has a point total of 0, 1, 2, 3, 4 or 5, the Player hand draws a third card. If the initial two card Player hand has a point total of 6 or 7, the Player hand stands and does not receive a third card.
Rule #2: If the Player hand stands and does not draw a third card, then the Banker hand follows Rule #1. In other words, if the Player hand has a point total of 6 or 7, the Banker hand draws a third card on a point total of 0, 1, 2, 3, 4 or 5 and the Banker hand stands on a point total of 6 or 7.
Rule #3: If the Player hand draws a third card, the Banker hand must draw or stand as follows:
1, 2, 3, 4, 5 or 10 Banker always draws
6, or 7, Banker draws
8 or 9 Banker stays.

A slightly alternative rule set includes:

In conventional baccarat, the bettors deal the cards used in the game. Initially, one of the casino dealers (called the “caller”) passes the shoe to the bettor sitting in seat number “1” at the baccarat table. After all wagers have been made, the caller tells the bettor with the shoe to begin the deal. The bettor deals a first card to the caller, a first card to himself, a second card to the caller and a second card to himself. All cards are dealt face down. The two cards given to the caller represent the player hand and the two cards kept by the bettor who is dealing the cards represent the bank hand.

The caller than allows one of the other bettors to turn up the player's hand. Traditionally, this honor is given to the bettor who has made the largest wager. The bettor turns up the two cards of the player's hand and tosses them to the caller. The caller places these two cards face up in the table location designated for the “player hand” and the caller announces the point total of the player hand.

The bettor who has the shoe then turns over the cards of the bank hand and tosses these two cards to the caller. The caller places these two cards face up in the table location designated for the “bank hand” and the caller announces to point total of the bank hand. Depending on the point total of the player's hand and the bank's hand, one more card may be dealt to either the player's hand, the bank's hand, or both. The rules for determining whether a third card is dealt are fixed rules, there is no discretion for either the player's hand or the bank's hand on whether a third card is dealt.

If either the player hand or the bank hand has a point total of eight or nine on the first two cards, no third card is dealt to either hand and the hand with the highest point total is the winner (or the hand is a tie, as the case may be). If neither the player hand or the bank hand has a point total of eight or nine, then there is a possibility of a third card draw.

The third card draw rules are as follows:
Rule #1: If the initial two card player hand has a point total of 0, 1, 2, 3, 4 or 5, draws a third card. If the initial two card player hand has a point total of 6 or 7, the player hand stands and does not receive a third card.
Rule #2: If the player hand stands and does not draw a third card, then the bank hand follows Rule #1. In other words, if the player hand has a point total of 6 or 7, the bank hand draws a third card on a point total of 0, 1, 2, 3, 4 or 5 and the bank hand stands on a point total of 6 or 7.
Rule #3: If the player hand draws a third card, the bank hand must draw or stand as described in Table 1.

TABLE 1

| Bank hand two | Bank hand draws when the | Bank hand stands when the |
|---|---|---|
| card point total | player's hand third card is: | player's hand third card is: |
| 0, 1 or 2 | Bank always draws | — |
| 3 | 0, 1, 2, 3, 4, 5, 6, 7 or 9 | 8 |
| 4 | 2, 3, 4, 5, 6 or 7 | 0, 1, 8 or 9 |
| 5 | 4, 5, 6 or 7 | 0, 1, 2, 3, 8 or 9 |
| 6 | 6 or 7 | 0, 1, 2, 3, 4, 5, 8 or 9 |
| 7 | — | Bank always stands |

All third card draw determinations are automatically made by the caller who is skilled in the game of baccarat. When the rules of baccarat require a third card for the player hand, the caller will request a card for the player hand. After the player hand is completed, the bank hand is completed in the same fashion. The caller then declares which hand has the highest point total and declares that hand the winner (or the caller declares a tie hand as the case may be).

In conventional baccarat the bettor who acts as the dealer continues to deal the cards until the player hand wins. As soon as the player hand wins, it is customary to pass the shoe counterclockwise around the baccarat table to the next bettor so that each bettor has the opportunity to deal the cards. Any bettor may decline to deal the cards. The fact that one of the bettors is physically dealing the cards has no affect on the outcome of the game because the rules for drawing and standing do not allow any discretion on the part of the players.

The players can play the game according to conventional baccarat rules, which may vary from place to place. In one embodiment, the baccarat game is played according to the U.S. rules as used in Las Vegas. In another embodiment, the baccarat game is played according to the baccarat rules promulgated by the government of Macau Special Administration Region.

In some embodiments, there is a maximum limit on the total bet can be made through a single betting terminal for the live baccarat game. In one embodiment, the maximum bet can be made through one terminal for live baccarat is, for example, HK$20,000.

At the end of each hand, winning wagers are paid and losing wagers are collected by the house. Any commission due to the house is marked in commission boxes in the center of the table. Gaming chips are used to represent the amount of money owed by each bettor to the house for the commissions. In order not to slow down the game, the commission is not actually collected from each bettor until the end of the round determined by all of the cards in the shoe being dealt down to the plastic cut card, usually approximately eighty hands.

In progressive gaming systems, various types of bet detector systems are used to assure that only player positions that make the progressive wager are entered in the gaming event. The dealer typically locks the progressive wager into the system before any playing cards are dealt. There are also typically indicator lights at each player position so that players and dealers are assured that the progressive wager has been made and has been accepted. Typical bet detectors include drop slots which detect the presence or passage of tokens or coins (e.g., U.S. Pat. Nos. 6,579,181; and 6,579,180) and proximity detectors from which wagers must be collected by a dealer (e.g., U.S. Pat. Nos. 6,568,678; and 6,561,897).

In paying out awards according to the gaming payout table, typically only one payment is made for a winning hand. If, for example the jackpot wager or the 6-card same suited hand is achieved, the smaller wager of 1-15 units for every 6-card hand is not also paid out.

The mathematical analysis of the game reveals that the 5% commission is what gives the house its advantage on wagers on the Banker hand and allows the gaming establishment to make a profit from providing the Baccarat game to the bettors. Because the rules for standing and drawing third cards are automatic, the mathematical analysis shows that the Banker hand will win 45.859% of the hands, the Player hand will win 44.624% of the hands and the Tie hand will occur 9.517% of the hands. If the Tie hands are disregarded because they do not affect any Player or Banker wagers, it is then determined that the Banker hand will win 50.7% of the time and the Player hand will win 49.3% of the time.

Because the Banker hand wins more than 50% of the hands (disregarding the Tie hands that do not affect any Player or Banker wagers), if a bettor always bet on the Banker hand, the bettor would have an advantage over the gaming establishment. By charging a 5% commission on all Banker hand wins, the gaming establishment compensates for the percentage of winning Banker hands being slightly over 50%.

After figuring in the 5% commission that must be paid by bettors on winning Banker hands, the gaming establishment has approximately a 1.23% advantage over the bettor when the bettor wagers on the Player hand and the gaming establishment has a 1.057% advantage over the bettor when the bettor wagers on the Banker hand. The Tie hand wager gives the gaming establishment a 4.88% advantage over the bettor when the payoff odds are nine-to-one and a 14.1% advantage over the bettor when the payoff odds are eight-to-one.

Because of the limited number of playing cards provided in baccarat, it has been difficult to design jackpots and progressive jackpots with a balance between sufficiently high hit frequency and sufficiently high jackpots that will maintain the interest of players.

U.S. Pat. No. 5,275,411 (Breeding) discloses a position of start indicator for Pai Gow poker games where a hand-position for first hands dealt is randomly indicated by a 7-segment display for positions 1-7. All references to Patent Documents made herein are incorporated by reference in their entirety.

U.S. Pat. No. 11,676,451 (Abrahamson) discloses a Progressive baccarat system in which ties of specific ranks are paid at specific player positions with a random number generator identifying specific tie values for specific player positions.

### SUMMARY OF THE INVENTION

A system and method of executing a game of baccarat with a progressive side bet event, the system comprising: a gaming table (physical or virtual) having positions thereon for placing an initial wager at the gaming table on the game of baccarat; the gaming table having positions thereon for placing a second wager on a progressive side bet event from at least one of at least two player positions at the gaming table on the game of baccarat resolved by using final playing cards dealt to the player hand position and final playing cards dealt to the banker hand position, wherein the outcome of the side bet event must always be determined by occurrence of a qualifying event of a final total of six playing cards being in play at the conclusion of a round of baccarat. The second wager must be automatically (electronically, with or without visual recognition systems) recognized by the system and in the method. Bet recognition systems which report the presence of a wager specific to the progressive event (As further described herein) may be used. This is an important security feature in the operation of the systems and methods of the invention.

A system enables a method of executing a game of baccarat with a side bet event (e.g., Progressive gaming event). The system includes a gaming table (real physical table or virtual EGM or online) with at least two distinct player positions. The gaming table having positions thereon for placing an initial wager on the game of baccarat and for placing a second wager on the side bet (e.g., Progressive event) event from at least one of at least two player positions at the gaming table on the game of baccarat, the side bet resolved by final playing cards at the player hand position and the banker hand position. Each of the at least two player positions has a secondary random outcome indicator display. The gaming table has a random event generator providing distinct random event outcome indicators to the secondary random outcome indicator displays at each player position and each distinct random event outcome indicator represents a single digit number value.

### BRIEF DESCRIPTION OF THE FIGURES

FIG. 1 shows an exploded side view perspective of a system according to the present invention.

FIG. 2A illustrates a processor is operatively coupled to memory.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture 300 that implements a game processing pipeline for the play of a game in accordance with various implementations described herein.

### DETAILED DESCRIPTION OF THE INVENTION

A method executes a game of baccarat with a side bet event. The game of baccarat may be a standard or variant game of baccarat in which a player hand of playing cards is in competition with a banker hand of playing cards. A player hand position and a banker hand position receive playing cards from at least one randomized deck of 52 playing cards.

A system enables a method of executing a game of baccarat with a progressive side bet event, the game of baccarat including a player hand of playing cards in competition with a banker hand of playing cards, a player hand position and a banker hand position receiving playing cards from at least one randomized deck of 52 playing cards, the system comprising: a gaming table with at least two distinct player positions at the gaming table; the gaming table having positions thereon for placing an initial wager from at least one player position at the gaming table on the game of baccarat; the gaming table having positions thereon for placing a second wager on a progressive side bet event from at least one of at least two player positions at the gaming table on the game of baccarat resolved by using final playing cards dealt to the player hand position and final playing cards dealt to the banker hand position, wherein the outcome of the side bet event must always be determined by occurrence of a qualifying event of a final total of six playing cards being in play at the conclusion of a round of baccarat. The system may have the second wager as a progressive jackpot wager and there is an automated accounting system associated with the gaming table. There is typically a payout table for the 6 final total of cards which include awards for at least three outcome events selected from the group consisting of:
a) 4 cards of a specific suit paying out between 100 and 2000 units,
b) Banker or Player 3 cards of a specific suit paying out between 75 and 500 units,
c) 5 cards of the same color paying out between 5 and 30 units, and
d) any 6 cards in the total of the Player and Banker hands paying out between 1 and 15 units.
1. The system of claim 1 herein there is a payout table for the 6 final total of cards which include awards for at least three outcome events selected from the group consisting of:
a) 4 cards of a specific suit paying out between 100 and 2000 units,
b) Banker or Player 3 cards of a specific suit paying out between 75 and 500 units,
c) 5 cards of the same color paying out between 5 and 30 units, and
d) any 6 cards in the total of the Player and Banker hands paying out between 1 and 15 units.

The system may have the progressive jackpot payout determined by at least one of all of the six total playing cards being same suited, the six total playing cards being the same rank, the six total playing cards forming a straight flush of at least five playing cards, the six total playing cards forming a straight of at least five playing cards, the six total playing cards forming a straight flush of six playing cards, the six total playing cards forming a group including at least five identically ranked or identical playing cards, the six total playing cards forming a group including six identically ranked or identical playing cards, and the six total playing cards forming a group including at least two sets of three identically ranked or identical playing cards. The system may commercially employ the progressive jackpot payout being determined by all of the six total playing cards being same suited.

The system may use a gaming table as a virtual gaming table shown on a display screen and in which virtual playing cards are provided by execution of a random number generator, and images of provided virtual playing cards are shown on the display screen, and a gaming processor executes software to account for jackpot accumulation and award payouts. The virtual system may have the gaming table as a display screen of an electronic gaming machine and in which virtual playing cards are provided by execution of a random number generator, and images of provided virtual playing cards are shown on the display screen, and a gaming processor executes software to account for jackpot accumulation and award payouts. The electronic gaming machine may further include one or more server computers that are in communication, via a communications network, with more than one gaming devices acting in concert to individually execute baccarat events with a common progressive jackpot.

A method of executing a game of baccarat with a progressive side bet event, the game of baccarat including steps of:
a) providing a player hand of playing cards in competition with a banker hand of playing cards, a player hand position and a banker hand position receiving playing cards from at least one randomized deck of 52 playing cards,
b) a bettor placing an initial wager on the game of baccarat;
c) the bettor placing a second wager on a progressive side bet event on the game of baccarat resolved by using final playing cards dealt to the player hand position and final playing cards dealt to the banker hand position,
wherein the outcome of the progressive side bet event must always be determined by occurrence of a qualifying event of a final total of six playing cards being in play at the conclusion of a round of baccarat.

The method may include:
placing of an initial wager from at least one of at least two player positions at a gaming table on the Player's hand, the Banker's hand or a Tie in the game of baccarat;
the at least one player position placing a second wager on a side bet (progressive wager) event resolved by using final playing cards dealt to the player hand position and final playing cards dealt to the banker hand position;

At the conclusion of providing the final hands of playing cards to the player hand position and the banker hand position:
resolving the initial wager according to standard rules of baccarat; and
resolving the second wager at the at least one player position as a highest winning outcome according the rules detailed above, wherein:

Examples of paytables include:

| Banker | | | | | | | | |
|---|---|---|---|---|---|---|---|---|
| 4, 5, 6 | Paytable 1 | | Paytable 2 | | Paytable 3 | | Paytable 4 | |
| 6-Cards | 100% | | 100% | | 100% | | 100% | |
| Suited | | | | | | | | |
| 4 Cards of a | 500 | units | 1000 | units | 1000 | units | 750 | units |
| specific suit | | | | | | | | |
| Banker 3 | 200 | units | 150 | units | 250 | units | 300 | units |
| cards of | | | | | | | | |
| specific suit | | | | | | | | |
| 5 cards same | 15 | units | 15 | units | 100 | units | 100 | units |
| color | | | | | | | | |
| Any 6 cards | 5 | units | 5 | units | 5 | units | 5 | units |

Further variations in the payout tables may be used, such as 4 cards of a specific suit paying out between 100 and 2000 units, Banker or Player 3 cards of a specific suit paying out between 75 and 500 units, 5 cards of the same color paying out between 5 and 30 units, and any 6 cards in the total of the Player and Banker hands paying out between 1 and 15 units. Other outcomes such as a 6-card straight, 6-card flush, 6-card straight flush, 6 identically ranked cards, 6 identical cards, etc. may be used for additional or alternative payouts.

The six different payment options on the Progressive wager are visually and/or automatically (by a processor receiving visual or sensed data of the respective numbers of cards and total points in the Player's hand and the Bankers hand), and the Progressive wager. The differentiation between a Progressive wager and a side bet wager is that with a Progressive wager, a portion of each wager placed by a bettor on that event accumulates in a Jackpot account. Jackpot accounts are typically seeded before any wagers are placed, as are lottery events typically prefunded.

Templates have been used in the art for provision of complete game outcomes, as shown in U.S. Pat. No. 6,159,096 (Yoseloff. That patent is incorporated by reference in its entirety herein.

A system for enabling a method of executing a game of baccarat with a side bet event. The game of baccarat may include a player hand of playing cards in competition with a banker hand of playing cards. A player hand position and a banker hand position receive playing cards from at least one randomized deck of 52 playing cards. The system may include:
the system including a gaming table with at least two distinct player positions at the gaming table;
the gaming table having positions thereon for placing an initial wager from at least one of at least two player positions at the gaming table on the game of baccarat;
the gaming table having positions thereon for placing a second wager on a side bet event from at least one of at least two player positions at the gaming table on the game of baccarat resolved by using final playing cards dealt to the player hand position and final playing cards dealt to the banker hand position;
each of the at least two player positions has a secondary random outcome indicator display;
the gaming table associated with a random event generator providing distinct random event outcome indicators with respect to the underlying game events qualifying for and determining the Progressive event awards. Indicators may be provided within the viewing area of the players indicating stages of the Progressive gaming event. Such an indicator or display may be associated with (attached to) the ‘display tree’ often used with games (baccarat and Roulette) to display recently completed gaming events.

The general technology is for a Baccarat Progressive Game for all formats of Baccarat (Live, ETG, Virtual, Online, and Mobile apps) which Applicant refers to as the “GOLDEN SIXES.” The systems may be operated preferably without any random number generator identifying specific results for different player positions. Alternatively, the random outcome generator and position outcome indicator of U.S. Pat. No. 11,676,451 (Abrahamson, which is incorporated in its entirety herein) may be used for an alternative purpose, to break ties on the outcome, and rank an order of payment at each player position. Thus the software of the system may recognize the order of 1, 2, 3 . . . 8 given to players at a table, and automatically adjust 100% jackpot outcomes proportionally as random player 1 received 50%, random player 2 receives 20%, and random players 3, 4, 5, 6, 7 and 8 receive 5% of the jackpot, or some other distribution. These may be such as random Player (rP)1 receives 25%, rP2 receives 20%, rP3 receives 15%, rP4-rP7 receive 10%.

Another way of reducing the impact of ties for the jackpot is to apportion the jackpot payout according to the size of the underlying wager of the players winning the jackpot. For example, the percentage of the jackpot would be apportioned by adding the total wagers (W) of players sub n1-8 that placed the jackpot wager (i.e., Σ (W)) divided into the amount that a winning jackpot player placed (e.g., Wₙ₁₋₈/Σ (W)). For example, with 8 players placing total wagers of 200 units (e.g., dollars), if three jackpot winning players had placed bets on the underlying game of 30, 25 and 10 units, the proportionate jackpot would be 30/65, 25/65 and 10/65, respectively.

A common problem with Baccarat Progressives is that since Baccarat is a community game, the combinations of cards in the hand that trigger a progressive jackpot do so for all of the players participating, and the players therefore have to split the progressive.

Although a preferred system for practice of the technology is a felt-type game, with physical playing cards or electronic playing cards used on a typical playing card gaming table structure, the system may be used in purely electronic gaming tables, multiplayer console formats, video electronic gaming formats, on internet gaming play, through hand-held devices and the like. Enablement of these formats for playing card games is known in the art with commercial and disclosed systems available for transposing the physical table game system into these electronic wagering formats. Such variations in format are disclosed, for example, in US Published Application Document No. 20070298854 (DUNN), which is incorporated herein by reference.

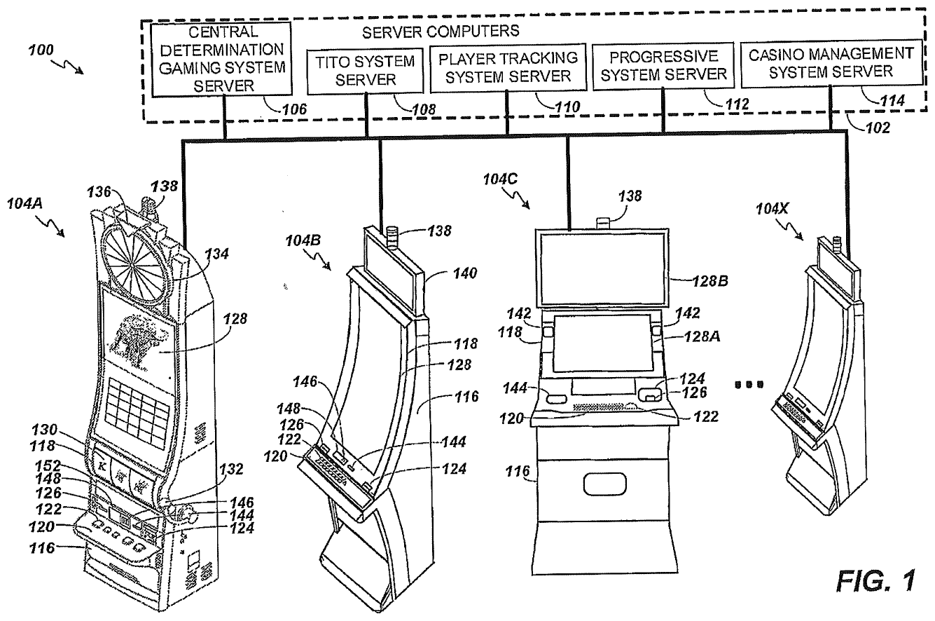

FIG. 1 shows an exploded perspective of a system according to the present invention. FIG. 1 shows a gaming table system 500 including a processor 526 assessing progress of the underlying game and the progressive event based on input from sensors or fed data from a pre-shuffled delivery show. The gaming table system 500 is shown with a physical support 502 and a gaming table top 504. The support 502 has a side 512 facing the dealer (not shown) and an upper game table surface 508. The upper game table surface 508 carries the processor 526 and any included circuitry 516 necessary for relaying the secondary processor directed events. The processor connection 526 is integrated or not into the system 500. The processor 526 and any included circuitry 516 is shown to be wired to separate and distinct individual player position visual output devices 518 a, 518 b, 518 c and 518 d by individual wires 517 to form a Progressive event generation component 506 which includes all elements of 516, 517, 518 a-d and 526.

The gaming table top 504 is supported under the surfaces 510 of the gaming table top 504 and the base support layer 502 which has a side facing 512 facing the dealer (not shown) and an upper support surface 508. The separate and distinct individual player position visual output devices 518 a, 518 b, 518 c and 518 d are exposed through holes or openings 520 a, 520 b, 520 c and 520 d in the gaming table cover layer 504. Each separate and individual player position is also shown with a side bet or jackpot bet sensing/entering input system as 530 a, 530 b, 530 c and 530 d, respectively. An alternative construction may include a communication port 524 in linked communication path 522 to an individual opening (520 c) as by a further direct connecting port 528 to each separate and distinct individual player position visual output devices 518 a, 518 b, 518 c and 518 d.

Other variants and modifications are within the generic scope of the present invention and are within the scope of the appended claims of this Application.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that might act in concert with one or more aspects of the present disclosure (as in U.S. Pat. No. 9,997,013, Litman). The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or game of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a web site maintained by a computer on a remote server or over an online data network including commercial online service providers, Internet service providers, private networks (e.g., local area networks known as LANs and enterprise networks), and the like (e.g., wide area networks known as WANs). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some single player implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number of frames with various symbols of gaming elements are shown displayed on them. The replacement of withdrawn gaming elements may be automatic or activated by player input 130 to show a set of symbols of gaming elements within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 130, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a top gaming content or entertainment display 100. When bonus play is triggered (e.g., by a player achieving a particular outcome or set of outcomes in the primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

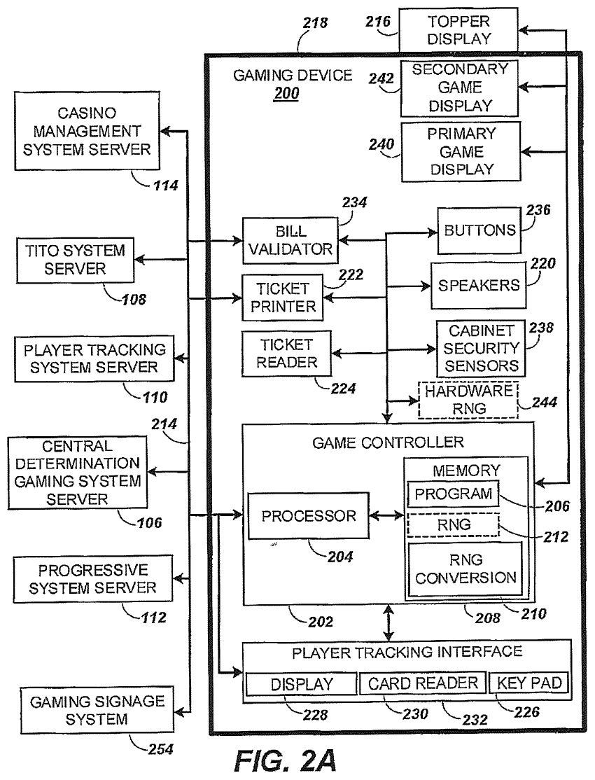

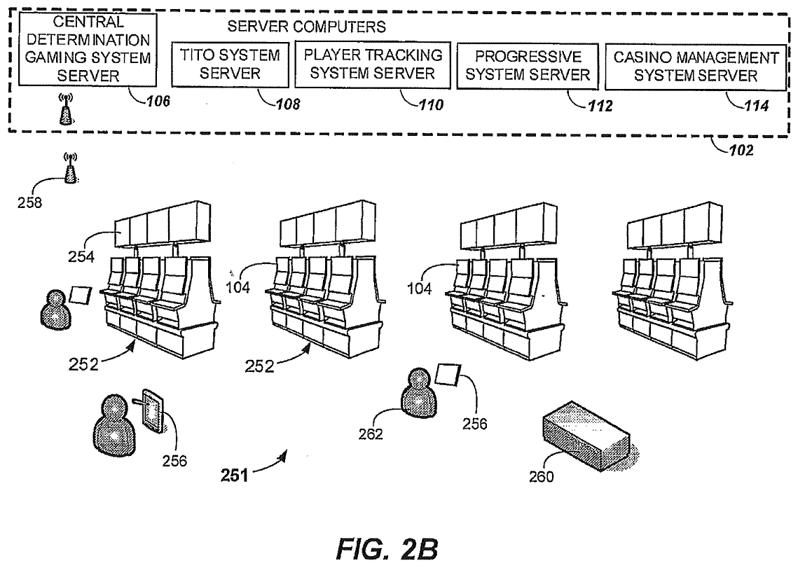

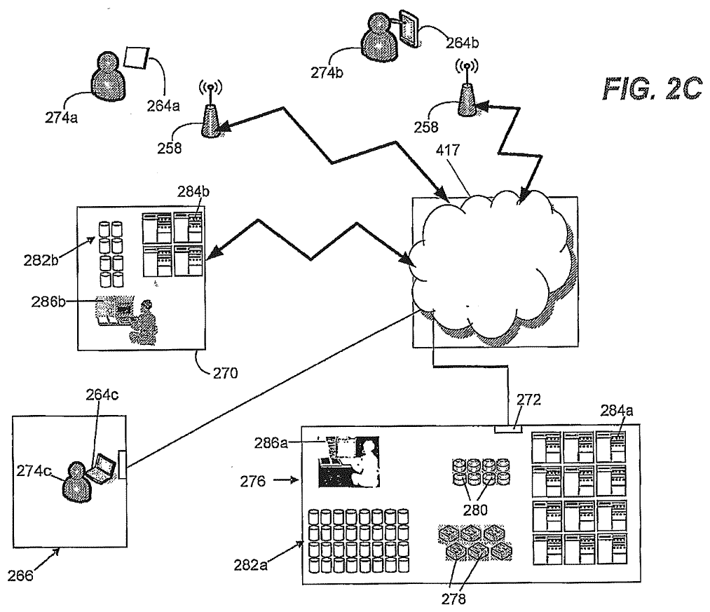

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The game available for play on the gaming device 200 are controlled by a game controller 202 that includes processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processor and/or one or more specialized processor.

Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that ame controller 202 includes a single memory 208, game controller 202 could include multiple memories 208 for storing program instructions and/or data.

Memory 208 can store one or more game programs 206 that provide program instructions and/or data for carrying out various implementations or variations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player.

The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a gaming element elimination and replacement game, game program 206 can initiate multiple RNG calls to RNG 212 to generate RNG outcomes, where each RNG call and RNG outcome corresponds to an outcome for a replacement or original delivery of a gaming element. In another example, gaming device 200 can be a Class II gaming device where RNG 212 generates RNG outcomes for creating secondary or jackpot events. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as specialty cards, differing shapes of gaming elements to assist in pairing eliminating combinations, or new cards; stop positions for dynamic game elements such as card placement, bonus reels; or gaming elements selections from a ste) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each gam outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

The game available for play on the gaming device are controlled by a game controller that includes processors. Processor represents a general-purpose processor, a specialized processor intended to perform certain functional tasks, or a combination thereof. As an example, a processor can be a central processing unit (CPU) that has one or more multi-core processing units and memory mediums (e.g., cache memory) that function as buffers and/or temporary storage for data. Alternatively, processor can be a specialized processor, such as an application specific integrated circuit (ASIC), graphics processing unit (GPU), field-programmable gate array (FPGA), digital signal processor (DSP), or another type of hardware accelerator. In another example, processor is a system on chip (SoC) that combines and integrates one or more general-purpose processor and/or one or more specialized processor. A game controller includes at least a single processor, but the game controller is not limited to this representation and instead can include multiple processors (e.g., two or more processors). The method may be stored on a non-transitory computer readable storage medium comprising computer readable code executable by one or more processors to: randomly determine, using a first random number generator output, display symbols on a display screen for a game controller executing instructions which cause the game controller to execute the herein described methods.

A processor is operatively coupled to memory. Memory is defined herein as including volatile and nonvolatile memory and other types of non-transitory data storage components. Volatile memory is memory that do not retain data values upon loss of power. Nonvolatile memory is memory that do retain data upon a loss of power. Examples of memory include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242.

Other game and prize information may also be displayed.

For each game instance, a player may make selections, which may affect play of the game. For example, the player may vary the total amount wagered by selecting the amount bet per gaming event line and the number of games and bonuses played. In many games, the player is asked to initiate or select options during course of game play (such as electing different paytables, selecting base numbers of original number of gaming elements displayed, spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is of course not limited to those implementations shown in FIGS. 1 and 2A. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of flipping gaming elements reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2A are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the game may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the gam according to selections made by a player and indicated via the player's EUD. In other examples, code for executing at least some of the game may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

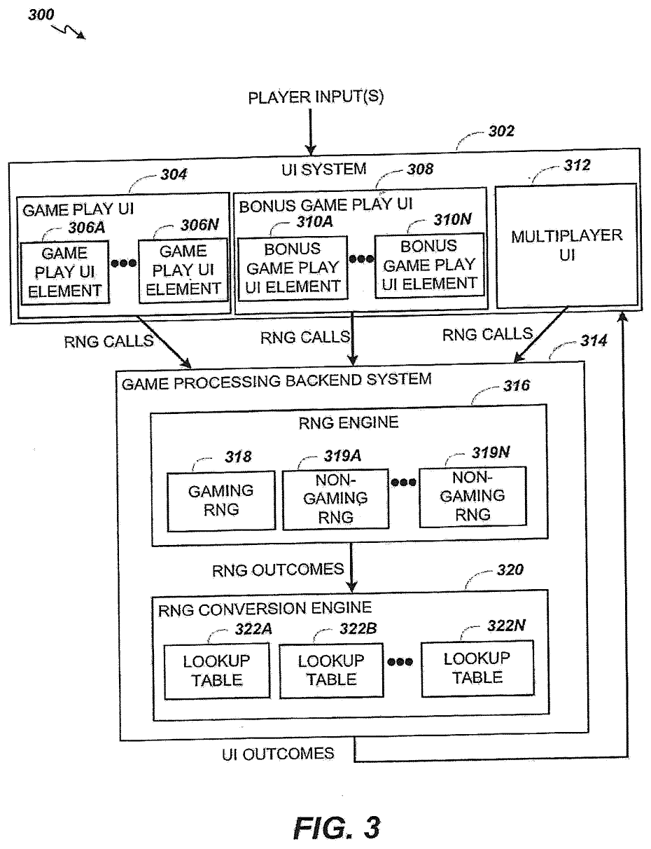

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual sets of gaming elements to be eliminated) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video screen or other virtual stopping point in game play. In one example, if the UI outcome is for a base game, the UI system 302 updates one or more game play UI elements 306A-306N, such as symbols, playing cards, tiles, images, etc., for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

The example game processing architecture 300 shown in FIG. 3 can be used to process game play instructions and generate outcomes as follows. In some example implementations, the game processing architecture 300 implements a game processing pipeline for a process (e.g., base gaming element game, bonus reel game, feature additional game, etc.) that converts consecutive winning outcomes that could contribute to a “win combination” to a single gaming event and selects a multiplier based on the number of preceding positive game outcomes, merge assigned multipliers of adjacent or consecutive games, or the like. The UI system 302 (e.g., the game play UI 304 or bonus game play UI 308 of the UI system 302) causes the display system (e.g. display 240, 242) to display a single symbol in place of a stacked reel and a multiplier assigned based on the number of preceding stacked reels, a merged multiplier representing the product of assigned multipliers of adjacent games or adjacent or associated EGMs, or the like. For a play, the UI system 302 (e.g., the game play UI 304 or bonus game play UI 308) makes one or more RNG calls to the game processing backend system 314. In response, the backend system 314 performs various operations. For example, using a gaming RNG 318, the RNG engine 316 generates one or more random numbers, which are passed to the RNG conversion engine 320. In various embodiments, the RNG conversion engine 320, can use one or more of the random number(s) and one or more of the lookup tables 322A . . . 322N, to determine a set of display symbols to populate the frames for displaying the gaming elements that can be eliminated, to select a selected special symbol to substitute for dynamic symbols, or the like. After determining a game outcome, including combining the product of assigned multipliers of associated display elements or screens that are part of a “win combination” (e.g. a payline etc., or the like, the backend system 314 performs a pay evaluation or otherwise determines results (e.g., calculating whether any win conditions exist). The backend system 314 returns generated result to the game play UI 304 or bonus game play UI 308 of the UI system 302, which can among other operations control display of the game outcome and results corresponding to the pay evaluation. For example, the game play UI 304 or bonus game play UI 308 in various embodiments may stop the spinning of reels at the display symbols determined for respective reel outcomes, replace eliminated gaming elements from frames (fully populated with special symbols) with a single symbol and a multiplier assigned based on the number of preceding positive events, merge assigned multipliers for adjacent stacked reels to display a single multiplier that is the product of the assigned multipliers, indicate win paths, or the like.

In general, the generated results returned by the backend system 314 can include game-related information (such as display symbols for the respective reels, outcomes) as well as animation effects not related to game parameters. Alternatively, the game play UI 304 (or bonus game play UI 308) can make one or more separate RNG calls to the backend system 314 to determine animation effects. In response, the backend system 314 can use the gaming RNG 318 and/or one or more of the non-gaming RNGs 319A . . . 319N to generate random numbers, which the RNG conversion engine 320 uses (with one or more of the lookup tables 322A . . . 322N) to determine animation effects. The game play UI 304 (or bonus game play UI 308) can perform operations consistent with the animation effects, which are returned from the backend system 314.

Although tie events may be incidental to the existence of a winning or even jackpot event, the fact of a tie is irrelevant to the determination of a winning outcome.

What is claimed:

1. A system for enabling a method of executing a game of baccarat with a progressive side bet event, the game of baccarat comprising a player hand of playing cards in competition with a banker hand of playing cards, a player hand position and a banker hand position receiving playing cards from at least one randomized deck of 52 playing cards, the system comprising: a gaming table with at least two distinct player positions at the gaming table; the gaming table having positions thereon for placing an initial wager from at least one player position at the gaming table on the game of baccarat; the gaming table having positions thereon for placing a second automatically recognized wager on a progressive side bet event from at least one of at least two player positions at the gaming table on the game of baccarat resolved by using final playing cards dealt to the player hand position and final playing cards dealt to the banker hand position, wherein the outcome of the side bet event must always be determined by occurrence of a qualifying event of a final total of six playing cards being in play at the conclusion of a round of baccarat.

2. The system of claim 1 wherein the second wager comprises a progressive jackpot wager and there is an automated accounting system associated with the gaming table.

3. The system of claim 1 wherein there is a payout table for the 6 final total of cards which include awards for at least three outcome events selected from the group consisting of:
a) 4 cards of a specific suit paying out between 100 and 2000 units,
b) Banker or Player 3 cards of a specific suit paying out between 75 and 500 units,
c) 5 cards of the same color paying out between 5 and 30 units, and
d) any 6 cards in the total of the Player and Banker hands paying out between 1 and 15 units.

4. The system of claim 1 herein there is a payout table for the 6 final total of cards which include awards for at least three outcome events selected from the group consisting of:
e) 4 cards of a specific suit paying out between 100 and 2000 units,
f) Banker or Player 3 cards of a specific suit paying out between 75 and 500 units,
g) 5 cards of the same color paying out between 5 and 30 units, and
h) any 6 cards in the total of the Player and Banker hands paying out between 1 and 15 units.

5. The system of claim 1 wherein the progressive jackpot payout is determined by at least one of all of the six total playing cards being same suited, the six total playing cards being the same rank, the six total playing cards forming a straight flush of at least five playing cards, the six total playing cards forming a straight of at least five playing cards, the six total playing cards forming a straight flush of six playing cards, the six total playing cards forming a group including at least five identically ranked or identical playing cards, the six total playing cards forming a group including six identically ranked or identical playing cards, and the six total playing cards forming a group including at least two sets of three identically ranked or identical playing cards.

6. The system of claim 2 wherein the progressive jackpot payout is determined by at least one of all of the six total playing cards being same suited, the six total playing cards being the same rank, the six total playing cards forming a straight flush of at least five playing cards, the six total playing cards forming a straight of at least five playing cards, the six total playing cards forming a straight flush of six playing cards, the six total playing cards forming a group including at least five identically ranked or identical playing cards, the six total playing cards forming a group including six identically ranked or identical playing cards, and the six total playing cards forming a group including at least two sets of three identically ranked or identical playing cards.

7. The system of claim 3 wherein the progressive jackpot payout is determined by at least one of all of the six total playing cards being same suited, the six total playing cards being the same rank, the six total playing cards forming a straight flush of at least five playing cards, the six total playing cards forming a straight of at least five playing cards, the six total playing cards forming a straight flush of six playing cards, the six total playing cards forming a group including at least five identically ranked or identical playing cards, the six total playing cards forming a group including six identically ranked or identical playing cards, and the six total playing cards forming a group including at least two sets of three identically ranked or identical playing cards.

8. The system of claim 1 wherein the progressive jackpot payout is determined by all of the six total playing cards being same suited.

9. The system of claim 1 wherein the gaming table comprises a virtual gaming table shown on a display screen and in which virtual playing cards are provided by execution of a random number generator, and images of provided virtual playing cards are shown on the display screen, and a gaming processor executes software to account for jackpot accumulation and award payouts.

10. The system of claim 1 wherein the gaming table comprises a virtual gaming table shown on a display screen of an electronic gaming machine and in which virtual playing cards are provided by execution of a random number generator, and images of provided virtual playing cards are shown on the display screen, and a gaming processor executes software to account for jackpot accumulation and award payouts.

11. The system of claim 10 in which the electronic gaming machine further comprises one or more server computers that are in communication, via a communications network, with more than one gaming devices acting in concert to individually execute baccarat events with a common progressive jackpot.

12. A method of executing a game of baccarat with a progressive side bet event, the game of baccarat comprising:
a) providing a player hand of playing cards in competition with a banker hand of playing cards, a player hand position and a banker hand position receiving playing cards from at least one randomized deck of 52 playing cards,
b) a bettor placing an initial wager on the game of baccarat;
c) the bettor placing a second wager on a progressive side bet event on the game of baccarat resolved by using final playing cards dealt to the player hand position and final playing cards dealt to the banker hand position,
wherein the outcome of the progressive side bet event must always be determined by occurrence of a qualifying event of a final total of six playing cards being in play at the conclusion of a round of baccarat.

13. The method of claim 12 wherein there is a payout table for the 6 final total of cards which include awards for at least three outcome events selected from the group consisting of:
a) 4 cards of a specific suit paying out between 100 and 2000 units,
b) Banker or Player 3 cards of a specific suit paying out between 75 and 500 units,
c) 5 cards of the same color paying out between 5 and 30 units, and
d) any 6 cards in the total of the Player and Banker hands paying out between 1 and 15 units; and
wherein awards are made to the bettor for winning outcomes on occurrence of any winning outcome events.

14. The method of claim 12 wherein the progressive jackpot payout is determined by all of the six total playing cards being same suited.

15. The method of claim 13 wherein the progressive jackpot payout is determined by all of the six total playing cards being same suited.

16. The method of claim 12 wherein the gaming table comprises a virtual gaming table shown on a display screen and in which virtual playing cards are provided by execution of a random number generator, and images of provided virtual playing cards are shown on the display screen, and a gaming processor executes software to account for jackpot accumulation and award payouts.

17. The method of claim 13 wherein the gaming table comprises a virtual gaming table shown on a display screen of an electronic gaming machine and in which virtual playing cards are provided by execution of a random number generator, and images of provided virtual playing cards are shown on the display screen, and a gaming processor executes software to account for jackpot accumulation and award payouts.

18. The method of claim 15 wherein the progressive jackpot payout is determined by all of the six total playing cards being same suited.

19. The method of claim 16 wherein the progressive jackpot payout is determined by all of the six total playing cards being same suited.

20. A non-transitory computer readable storage medium comprising computer readable code executable by one or more processors to: randomly determine, using a first random number generator output, display symbols on a display screen for a game controller executing instructions which cause the game controller to execute the method of claim 12.
